(19) United States
(12) Patent Application Publication
(10) Pub. No.: US 2022/0381058 A1
(43) Pub. Date: Dec. 1, 2022

(54) ELECTRONIC LOCK FEATURING FOOLPROOFNESS AND REPOSITIONABILITY

(71) Applicant: GIANNI INDUSTRIES INC., NEW TAIPEI CITY (TW)

(72) Inventor: CHIH CHUNG CHANG, NEW TAIPEI CITY (TW)

(21) Appl. No.: 17/335,023

(22) Filed: May 31, 2021

(51) Int. Cl. E05B 15/02

(52) U.S. Cl. CPC E05B 15/0245; E05B 47/0002

(57) ABSTRACT

Provided is an electronic lock featuring foolproofness and repositionability, including: a lock body, which is formed with teeth and a receiving cavity; a repositionable plate, which is formed with an elongated hole, a perforated portion, and a projecting spot, and is formed, on an underside thereof, with teeth, such that the teeth of the underside of the repositionable plate and the teeth of the lock body are mutually engageable with each other and the elongated hole of the repositionable plate is fixable to the receiving cavity of the lock body by a fastening element, and an escutcheon, which is formed with a fixing hole and a foolproof hole, such that the escutcheon is fit, by means of the foolproof hole, to the projecting spot of the repositionable plate and the escutcheon is fixed to the perforated portion of the repositionable plate by a fastening element.

### TECHNICAL FIELD OF THE INVENTION

The present invention relates to an electronic lock, and more particularly to an electronic featuring foolproofness and repositionability.

### DESCRIPTION OF THE PRIOR ART

An electronic lock, such as that disclosed in Taiwan Utility Model M33037, is mounted to one side of a door frame and a lock catch is controllable by an electromagnetic valve to activate or deactivate, so as to allow a bolt of a door to move in and out through the lock catch when the door is opened or closed, or to block the bolt.

Generally, the electronic lock is operated through the electromagnetic volve controlling the in and out movement of the bolt. To install the electronic lock, an escutcheon or cover plate must be removed first in order to mount the electronic lock in a cavity formed in a door frame. After the mounting is done, the escutcheon is attached to the electronic lock. This causes a problem that the escutcheon may not be readily aligned with the electronic lock in attaching the escutcheon to the electronic lock, and further adjustment may not be available.

### SUMMARY OF THE INVENTION

In view of the above-discussed problems of the known electronic lock, an objective of the present invention is to provide an electronic lock that features foolproofness and repositionability.

To achieve the above objective, the present invention provides an electronic lock featuring foolproofness and repositionability, which comprises:

a lock body, the lock body comprising an electromagnetic lock, the lock body being formed with a plurality of teeth and at least one receiving cavity;

a repositionable plate, the repositionable plate being formed with at least one elongated hole, at least one perforated portion, and at least one projecting spot, the repositionable plate being formed, on an underside thereof, with a plurality of teeth, the teeth formed on the underside of the repositionable plate being engageable with the teeth of the lock body, the elongated hole of the repositionable plate being fixed to the receiving cavity of the lock body by means of a fastening element; and

an escutcheon, the escutcheon being formed with at least one fixing hole and at least one foolproof hole, the escutcheon being fit, through the foolproof hole, to the projecting spot of the repositionable plate, the escutcheon being combined with and fixed to the perforated portion of the repositionable plate by means of at least one fastening element.

The teeth provided on the lock body and the teeth provided on the underside of the repositionable plate are arranged in mating engagement with each other in a manner of being adjustable through repositioning relative to each other in order to be set at a desired position relative to each other and are then fixed together by means of the fastening element extended through the elongated hole of the repositionable plate and penetrating into the receiving cavity of the lock body, thereby achieving an effect of repositioning. Further, the escutcheon is formed with at least one foolproof hole that receives the projecting spot of the repositionable plate to fit therein, so that easy fitting of the projecting spot can be achieved during assembling and an effect of foolproofness can be provided.

### BRIEF DESCRIPTION OF THE DRAWINGS

FIG. 1 is a perspective view showing the present invention.

FIG. 2 is an exploded view showing the present invention.

FIG. 3 is another exploded view of the present invention.

FIG. 4 is a perspective view of the present invention taken from a different angle.

FIG. 5 is a schematic view demonstrating repositioning of the present invention.

### DETAILED DESCRIPTION OF THE PREFERRED EMBODIMENT

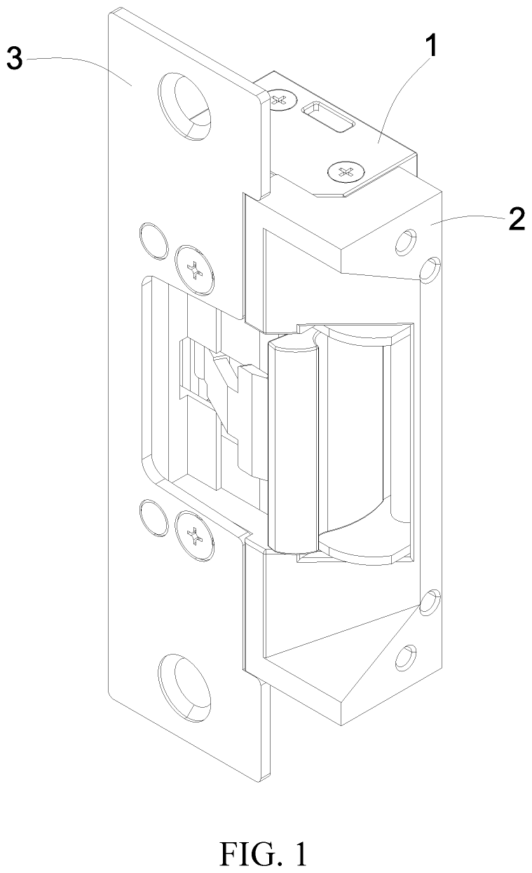

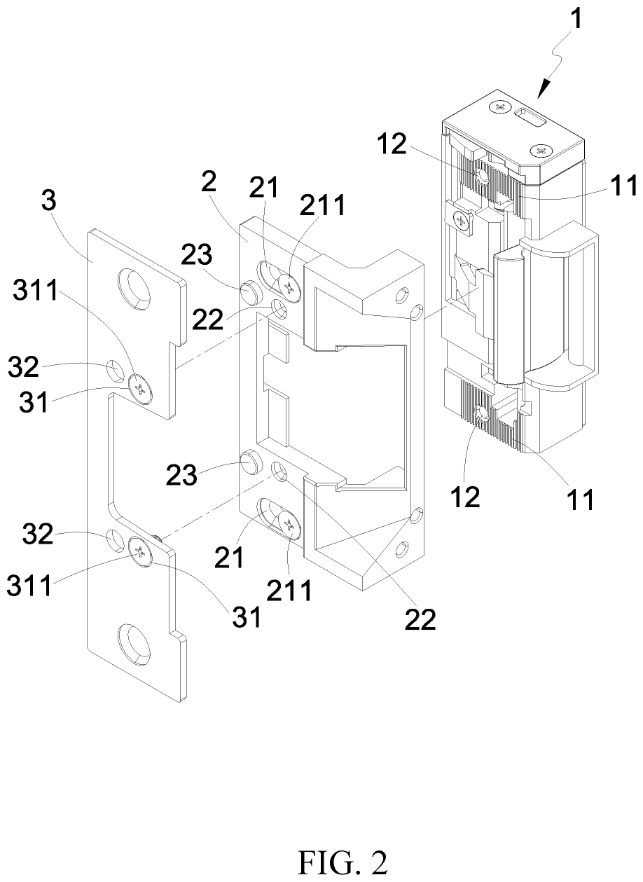

Referring to FIGS. 1 and 2, an electronic lock that includes functions of foolproofness and repositionability is provided, comprising:

a lock body 1, wherein the lock body 1 is an electromagnetic lock and the lock body 1 is formed with a plurality of teeth 11 and at least one receiving cavity 12;

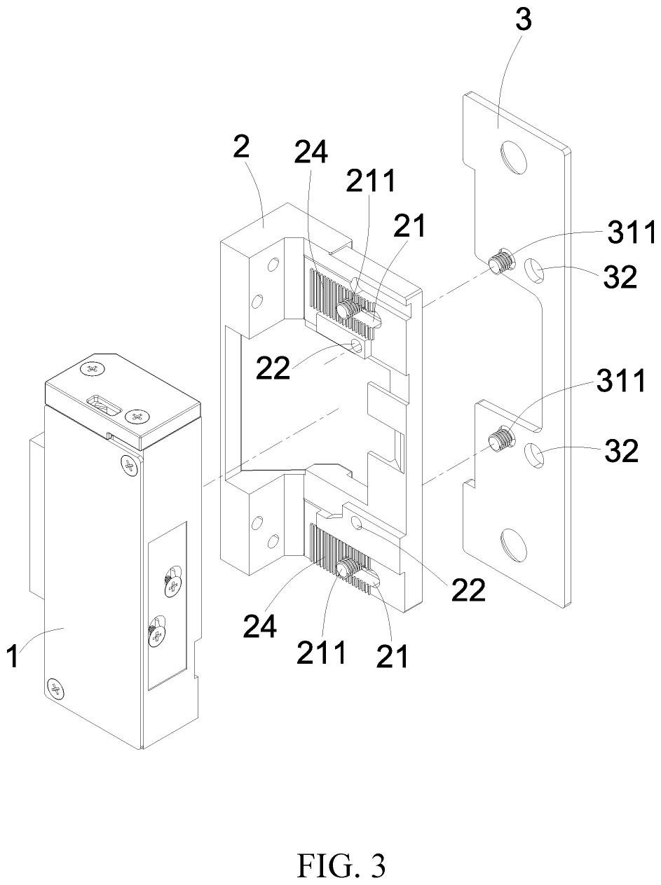

a repositionable plate 2, wherein the repositionable plate 2 is formed with at least one elongated hole 21, at least one perforated portion 22, and at least one projecting spot 23, and the repositionable plate 2 is formed, on an underside thereof, with a plurality of teeth 24, such that, as shown in FIG. 3, the teeth 24 on the underside of the repositionable plate 2 and the teeth 11 of the lock body 1 are mutually engageable with each other and each of the at least one elongated hole 21 of the repositionable plate 2 is fixed to a corresponding one of the at least one receiving cavity 12 of the lock body 1 by means of a fastening element 211; and

an escutcheon 3, wherein the escutcheon 3 is formed with at least one fixing hole 31 and at least one foolproof hole 32, and the escutcheon 3 is fit, by means of the at least one foolproof hole 32, to the at least one projecting spot 23 of the repositionable plate 2, and the escutcheon 3 is attached to and fixed to the at least one perforated portion 22 of the repositionable plate 2 by means of at least one fastening element 311.

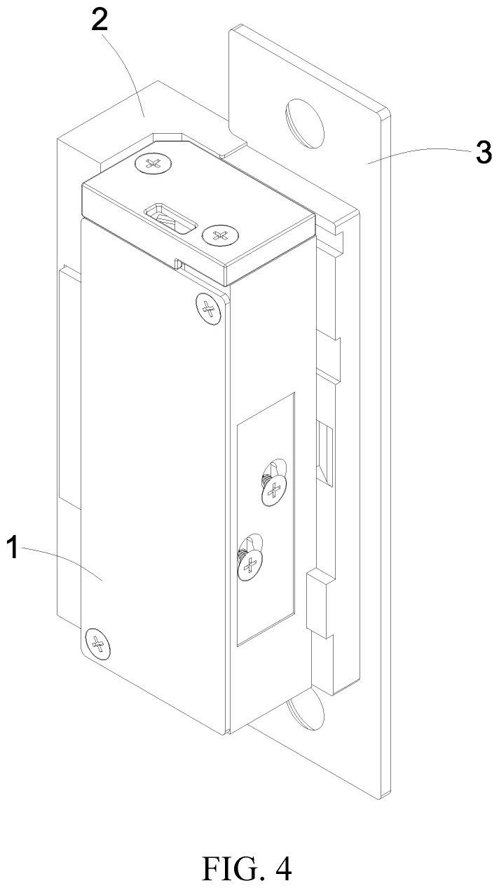

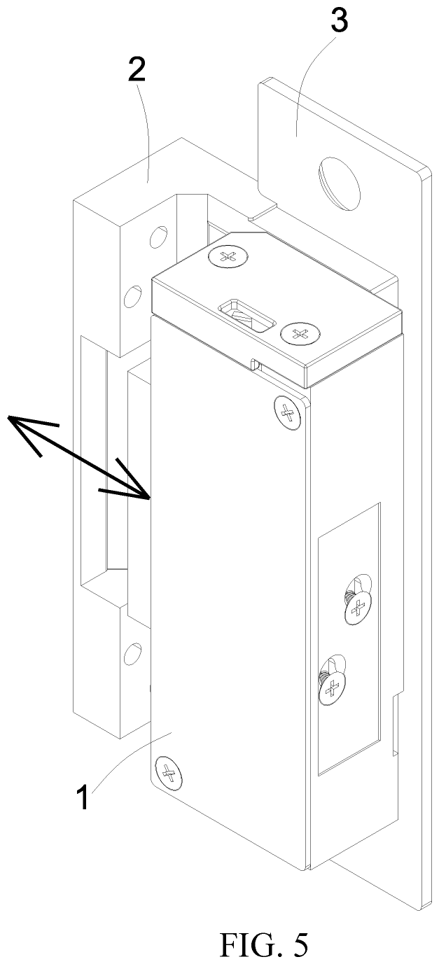

The teeth 11 provided on the lock body 1 and the teeth 24 provided on the underside of the repositionable plate 2 are arranged in mating engagement with each other in a manner of being adjustable through repositioning relative to each other in order to be set at a desired position relative to each other and are then fixed together by means of the fastening element 211 extended through the elongated hole 21 of the repositionable plate 2 and penetrating into the receiving cavity 12 of the lock body 1, thereby achieving an effect of repositioning, as clearly demonstrated in FIGS. 4 and 5. Further, the escutcheon 3 is formed with at least one foolproof hole 32 that receives the projecting spot 23 of the repositionable plate 2 to fit therein, so that easy fitting of the projecting spot 23 can be achieved during assembling and an effect of foolproofness can be provided.

Interior structure of the above-discussed lock body, and also technical features and operation thereof, is not a novel part of this invention and is simply omitted herein, as it is well known in the art.

I claim:

1. An electronic lock featuring foolproofness and repositionability, comprising:
a lock body, which is formed with a plurality of teeth;
a repositionable plate, which is formed with at least one projecting spot, the repositionable plate being formed, on an underside thereof, with a plurality of teeth, the plurality of teeth on the underside of the repositionable plate being engageable with the teeth of the lock body; and
an escutcheon, which is formed with at least one foolproof hole, the foolproof hole of the escutcheon being combinable, through fitting, with the projecting spot of the repositionable plate.

2. The electronic lock featuring foolproofness and repositionability according to claim 1, wherein the lock body is formed with at least one receiving cavity.

3. The electronic lock featuring foolproofness and repositionability according to claim 1, wherein the repositionable plate is formed with at least one elongated hole.

4. The electronic lock featuring foolproofness and repositionability according to claim 1, wherein the repositionable plate is formed with at least one perforated portion.

5. The electronic lock featuring foolproofness and repositionability according to claim 1, wherein the escutcheon is formed with at least one fixing hole.

6. The electronic lock featuring foolproofness and repositionability according to claim 3, wherein the elongated hole of the repositionable plate is provided with a fastening element.

7. The electronic lock featuring foolproofness and repositionability according to claim 5, wherein the fixing hole of the escutcheon is provided with a fastening element.

8. The electronic lock featuring foolproofness and repositionability according to claim 1, wherein the lock body comprises an electromagnetic lock.
